(19) United States
(12) Patent Application Publication
(10) Pub. No.: US 2004/0199671 A1
(43) Pub. Date: Oct. 7, 2004

(54) Communication assisting apparatus for mediating data transfer and communication system employing the communication assisting apparatus

(75) Inventors: Masahide Kaneko, Tokyo (JP); Makoto Oota, Tokyo (JP); Masatoshi Kimura, Tokyo (JP)

Correspondence Address: McDERMOTT, WILL & EMERY, 600 13th Street, N.W., Washington, DC, 20005-3096, US

(73) Assignees: RENESAS TECHNOLOGY CORP.; RENESAS SOLUTIONS CORPORATION

(21) Appl. No.: 10/720,106

(22) Filed: Nov. 25, 2003

(30) Foreign Application Priority Data
Feb. 18, 2003 (JP) P2003-39896

(51) Int. Cl. G06F 15/16

(52) U.S. Cl. 709/249

(57) ABSTRACT

A communication assisting apparatus is provided for mediating data transfer between a first data processing apparatus and a second data processing apparatus. The communication assisting apparatus includes a first connection unit, a memory and a second connection unit. The first connection unit is connected by wire with the first data processing apparatus, and receives data from the first data processing apparatus. The memory stores therein the data received by the first connection unit. The second connection unit is connected by wireless with the second data processing apparatus, and transmits the data read out from the memory to the second data processing apparatus. The communication assisting apparatus further includes a processing section which reads out the data stored in the memory according to a state of communication with the second data processing apparatus.

### BACKGROUND OF THE INVENTION

1. Field of the Invention

The present invention relates to a technology for improving the operating efficiency of a computer in a computer system and stabilizing the operation, and in particular, to a communication assisting apparatus for mediating data transfer between a first data processing apparatus and a second data processing apparatus, and a communication system employing the same communication assisting apparatus.

2. Description of the Related Art

Conventionally, there has been widely known network communications, which are achieved by connecting by wire or by wireless a plurality of personal computers (each referred to as a PC hereinafter) provided in a computer system, and which are provided for communicating data among the PCs. For example, a local area network (referred to as a LAN hereinafter) is one example of this kind of computer system for executing network communication. In a computer system for executing network communication, for sharing data by a plurality of PCs, it is necessary to share memory areas of a storage device such as a hard disk drive (referred to as an HDD hereinafter) of the PC which stores data (See, for example, Japanese Patent Laid-Open Publication No. JP 9-91217 A).

On the other hand, there is also an apparatus provided with a buffer memory for temporarily storing communication data. This kind of apparatus is connected by wire with a PC for executing data communication and the other apparatuses such as printers or the like, and the data transmitted from the PC is stored in the buffer memory. Even when data transmission cannot be achieved due to a problem occurring in the PC, the data stored in the buffer memory can be transmitted to the other apparatuses, and any error can be prevented from being caused (See, for example, Japanese Patent Laid-Open Publication No. JP 6-168082 A).

During network communications, the processing operation of a central processing unit (CPU) of the PC provided with the objective HDD to be shared may be sometimes disturbed. This is because the data bus of the PC is occupied and the transfer of the other data is limited during access to the HDD. When accesses to specific data is concentrated more than necessary or when security is not perfect, there may be also a risk of halt of the PC to be shared.

In order not to share information more than necessary, each of the plurality of PCs is allowed to have security set individually and setting contents altered. However, it is troublesome to provide security setting only for each PC and in particular for specific data, and the possibility of causing human errors increases according to an increase in the number of objectives of setting. This also leads to a factor of a security hole. For the above-mentioned reasons, there is a serious problem upon sharing the data of an HDD in the network communication.

When a network communication is executed by wireless, it may be a possibility of deterioration of transmission state, and this leads to failing in data communication between the PC on the side of transmitter where data is stored and the terminal unit on the side of receiver. In this case, the deterioration of the transmission state means, for example, existence of obstacles and superimposition of noise signal irrelevant to the data to be transmitted. In a use environment of an unstable transmission state, the processing at the terminal unit of the PC on the side of transmitter or the like cannot be stabilized.

### SUMMARY OF THE INVENTION

Accordingly, it is an essential object of the present invention to provide a communication assisting apparatus which is capable of reducing processing load on the side of data transmitter and stabilizing its processing.

Further, it is another object of the present invention to provide a communication network which is capable of reducing processing load on the side of transmitter and stabilizing its processing.

In order to achieve the above-mentioned objective, according to one aspect of the present invention, there is provided a communication assisting apparatus for mediating data transfer between a first data processing apparatus and a second data processing apparatus. The communication assisting apparatus includes a first connection unit, a memory, and a second connection unit. The first connection unit is connected by wire with the first data processing apparatus, and receives data from the first data processing apparatus. The memory stores therein the data received by the first connection unit. The second connection unit is connected by wireless with the second data processing apparatus, and transmits the data read out from the memory to the second data processing apparatus.

### BRIEF DESCRIPTION OF THE DRAWINGS

These and other objects and features of the present invention will become clear from the following description taken in conjunction with the preferred embodiments thereof with reference to the accompanying drawings throughout which like parts are designated by like reference numerals, and in which:

FIG. 1 is a schematic perspective view showing a computer network system 110 according to a first preferred embodiment of the present invention;

FIG. 2 is a block diagram showing a construction of a communication assisting apparatus 100 of the first preferred embodiment;

FIG. 3 is a sequential chart showing a processing flow executed by the computer network of FIG. 1;

FIG. 4 is a schematic perspective view showing a communication system 140 according to a first modified preferred embodiment of the present invention;

FIG. 5 is a schematic perspective view showing a communication system 150 according to a second preferred embodiment;

FIG. 6 is a block diagram showing a construction of a communication assisting apparatus 200 of the second preferred embodiment of the present invention; and

FIG. 7 is a schematic perspective view showing a communication system 170 including all the constructions of FIGS. 1, 4 and 5.

### DETAILED DESCRIPTION OF THE PREFERRED EMBODIMENTS

Preferred embodiments of the present invention will be described below with reference to the accompanying drawings.

First Preferred Embodiment

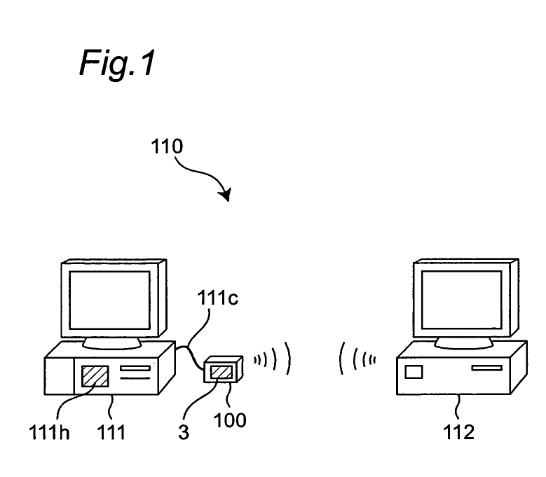

FIG. 1 is a view showing a computer network communication system 110 according to the first preferred embodiment of the present invention. The communication system 110 is constituted by connecting a plurality of data processing apparatuses each of a personal computer (referred to as a PC hereinafter) so as to enable data communication among the PCs. In order to simplify the description in the specification, only two PCs 111 and 112 are shown in FIG. 1. A hard disk drive (referred to as an HDD hereinafter) 111h of a storage device provided within the PC 111 is shared by the PC 111 and the PC 112. The PC 112 can access the HDD 111h of the PC 111 and read out data from the PC 111. In the following description, it is assumed that the PC 111 is located on the side of transmitter and the PC 112 is located on the side of data receiver.

In the communication system 110, the PC 111 and the PC 112 execute data communication via a communication assisting apparatus 100 of the first preferred embodiment. The communication assisting apparatus 100 is connected with the PC 111 by wire via wiring means such as a cable 111c, and is connected by wireless or air with the PC 112. The communication assisting apparatus 100 is provided for assisting the communication between the PC 111 and the PC 112. In the present specification, description is made on the assumption that the wire connection utilizes a connection using, for example, the USB (Universal Serial Bus; referred to as the USB hereinafter) standard, and the wireless connection utilizes a connection using the Bluetooth (referred to as the BT hereinafter) standard. Needless to say, the PC 111 is provided with an USB terminal, and the PC 112 is provided with a communication section of the BT standard. It is also acceptable to utilize the IEEE1394 interface in place of the USB, and to utilize the IEEE802.11 interface in place of the BT standard, as the wire and wireless standards, respectively.

One of the features of the communication assisting apparatus 100 includes such an arrangement that a memory 3 for storing data is provided within the communication assisting apparatus 100, and the data sent from the PC 111 is temporarily stored in the memory 3 when the PC 111 transmits data to the PC 112. Concretely speaking, the data is received by wire from the PC 111 and is stored in the memory 3, and thereafter, the data is transmitted by wireless to the PC 112. The transmission data to be transmitted is stored by providing at least the PC 111 located on the side of transmitter with the communication assisting apparatus 100 having the memory 3. Therefore, the PC 111 provided with the communication assisting apparatus 100 becomes a free state, or a standby state (or idling state) after judging that at the timing when the data to be transmitted has been handed over to the communication assisting apparatus 100, then transmission of the data is completed. At that time, an internal bus thereof is opened to allow the other processing to be executed. At this time, there is no concern as to whether the data has been actually transmitted to the PC 112.

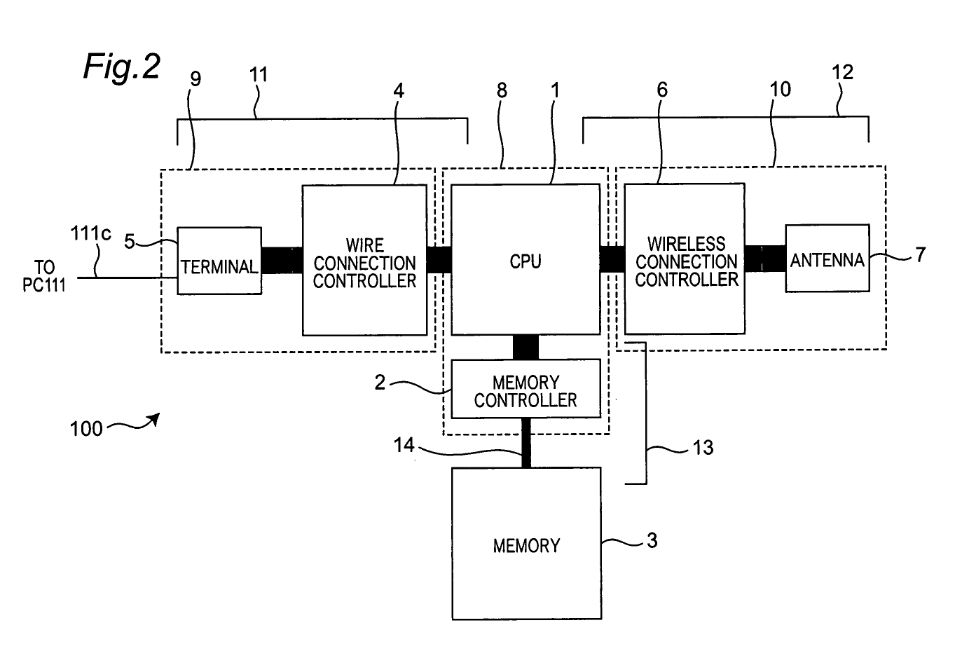

FIG. 2 is a block diagram showing a construction of the communication assisting apparatus 100 of the first preferred embodiment. Referring to FIG. 2, the communication assisting apparatus 100 is provided roughly with a memory 3, a main unit 8, a wire connection unit 9, and a wireless connection unit 10. According to the above-mentioned USB standard, an electric power (or bus power) is supplied from the PC 111 to the communication assisting apparatus 100, and the communication assisting apparatus 100 can operate based on the electric power. Therefore, no power supply unit is specifically shown in FIG. 2. However, the communication assisting apparatus 100 may be separately provided with an appropriate detachable power supply unit (not shown).

The components of the communication assisting apparatus 100 will be described below. The memory 3 is made of a well-known flash memory that communicates data with the main unit 8 via a path 13. Otherwise, the memory 3 may be either a non-volatile memory such as EEPROM, EPROM and EAROM or a volatile memory such as DRAM and SDRAM. The main unit 8 controls the operation of the communication assisting apparatus 100. The main unit 8 includes a central processing unit (referred to as a CPU hereinafter) 1 and a memory controller 2. The CPU 1 executes bi-directional communication with the wire connection unit 9. The CPU 1 also executes bi-directional communication with the wireless connection unit 10. The CPU 1 transmits to the memory controller 2, data which is received or communicated with the wire connection unit 9 and data which is received or communicated with the wireless connection unit 10, and then simultaneously transmits a write command or a read command to the memory controller 2. The memory controller 2 controls the write and read operations of the memory 3 according to the command from the CPU 1. Concretely speaking, the memory controller 2 writes data into an appropriate address of the memory 3, and reads out data from the memory 3 via a data bus 14. The data is read out from a specified address of the memory 3.

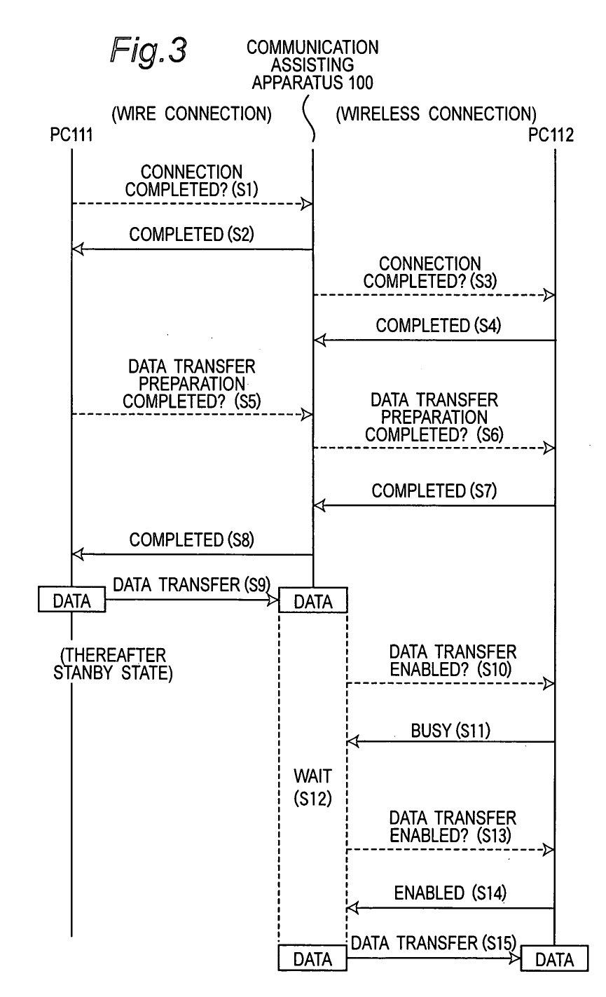

Although the memory bus 14 is shown using one path in FIG. 2 for the sake of convenience, the memory bus 14 may be constituted by including a plurality of paths according to the functions and characteristics of the memory 3 to be used. In particular, when the memory 3 has a dual operation function to execute the read operation parallel to the write operation in a manner similar to that of a flash memory or the like, the memory bus 14 is preferably constituted by including a plurality of paths. The principal operation of the communication assisting apparatus 100 achieved by the main unit 8 will be described later with reference to FIG. 3.

Next, the wire connection unit 9 and the wireless connection unit 10 of the communication assisting apparatus 100 will be described. The wire connection unit 9 has a function concerning the USB connection with the PC 111 of FIG. 1. The wire connection unit 9 is provided with a wire connection terminal 5 for establishing the connection between the wire connection controller 4 and the PC 111. In this case, the wire connection controller 4 is made of a well-known USB controller that communicates data through a path 11. That is, the wire connection controller 4 specifies the data on the basis of the signal received at the terminal 5, and sends the data to the CPU 1. Otherwise, the wire connection controller 4 converts the data received from the CPU 1 into a signal, and then sends the same signal to the PC 111 (not shown) via the terminal 5. On the other hand, the wireless connection unit 10 has a connection function conforming to the BT standard for connection with the PC 112 of FIG. 1. The wireless connection unit 10 is provided with a wireless connection controller 6 and an antenna 7, so as to execute wireless communication with the PC 112 of FIG. 1. In this case, the wireless connection controller 6 is made of a well-known BT controller that communicates data through a path 12. That is, the wireless connection controller 6 specifies the data on the basis of the signal received by the antenna 7, and sends the specified data to the CPU 1. Otherwise, the wireless connection controller 6 sends the data received from the CPU 1 through the antenna 7 to the PC 112 by using radio wave.

Referring again to FIG. 1, the communication assisting apparatus 100 and the PC 111 are connected with each other by way of the cable 111c which connects the terminal 5 of the communication assisting apparatus 100 with the PC 111. Needless to say, it is to be noted that the communication assisting apparatus 100 can be also constituted without using any cable 111c. For example, it is noted that it is acceptable to constitute the communication assisting apparatus 100 in a size of portable compact card such as in a form of so-called PC card or the like, and then the PC card have a PC card interface in place of the terminal 5 for the USB. In this case, the cable 111c is not exposed to the outside of the PC 111 since the PC card is inserted into the PC 111.

FIG. 3 is a sequential chart showing a processing flow executed by the communication system 110 of FIG. 1. Description is made hereinafter on the assumption that data is transmitted from the PC 111 to the PC 112 via the communication assisting apparatus 100 as described above.

The details of the processing flow are as follows. First of all, the PC 111 inquires whether or not connection (wire connection) with the communication assisting apparatus 100 has been completed (S1). If the connection is completed, then the CPU 1 of FIG. 2 of the communication assisting apparatus 100 sends a response about the connection completed to the PC 111 (S2). By this operation, the PC 111 can confirm the completion of the connection. Next, the CPU 1 of the communication assisting apparatus 100 establishes a wireless connection with the PC 112, and then inquires of the PC 112 about whether or not the connection has been completed (S3). If the connection is completed, then the PC 112 sends a response about the connection completed to the communication assisting apparatus 100 (S4). At this timing, the connection for communicating data is established between the PC 111 and the PC 112 via the communication assisting apparatus 100.

If the connection between the PC 111 and the PC 112 is established, then the PC 111 inquires of the PC 112 about whether or not data transfer can be executed with the PC 112, i.e., whether or not preparation for actually executing data transfer has been completed in the PC 112 (S5 and S6). If the preparation has been completed, then the PC 112 sends a response about the event via the communication assisting apparatus 100 (S7 and S8). At this time, the CPU 1 of the communication assisting apparatus 100 mediates these inquiries and responses via the path 11 and the path 12, not via the memory 3 of FIG. 2 of the communication assisting apparatus 100. In this case, the CPU 1 converts the signal inputted from the wire connection controller 4 into a signal of a signal system appropriate for the wireless connection controller 6 by using a transmission function.

Upon confirming that the data transfer with the PC 112 is allowed, the PC 111 transfers desired data to the communication assisting apparatus 100 (S9). At this timing, the PC 111 judges that the data transfer to the PC 112 has been completed, and the PC 111 becomes free of job.

The CPU 1 of the communication assisting apparatus 100 receives data from the PC 111, temporarily stores the received data in the memory 3, and retains the data therein. Then, the CPU 1 checks the state of communication with the PC 112. In this case, the CPU 1 inquires of the PC 112 about whether or not data transfer is currently allowed (S10). If the PC 112 returns a “busy” signal representing the fact that data transfer is currently not allowed, then the CPU 1 temporarily suspends the data transfer and awaits for a predetermined time (S12). If there is neither “busy” nor the other reply, then the CPU 1 judges that communication is impossible, temporarily suspends the data transfer and awaits for a predetermined time. After a lapse of the predetermined time, the CPU 1 again inquires of the PC 112 about whether data transfer is currently allowed (S13). If the PC 112 returns a reply of the event that the data transfer is allowed (S14), then the CPU 1 reads out the data retained in the memory 3 and transfers the data to the PC 112 (S15).

Since the data is retained in the memory 3 even when the data transfer has been started but not completed due to an obstacle or the like, the communication assisting apparatus 100 can transmit again the data from the memory in a state independent of the processing operation of the PC 111.

As described above, the data is transferred from the PC 111 to the PC 112 via the communication assisting apparatus 100. After transferring the data to the communication assisting apparatus 100, the PC 111 can shift to the next processing even when the data is not actually transferred to the PC 112. Therefore, the operating efficiency of the PC 111 can be remarkably improved. Moreover, since the PC 111 is not connected with any apparatus other than the communication assisting apparatus 100, the PC 111 can operate without being influenced by the state of communication. Therefore, stabilization of operation can be also achieved. Furthermore, when the state of communication is deteriorated and connection is cut off, the PC 111 is not required to transfer again the data since the data is stored in the memory 2 of FIG. 2 of the communication assisting apparatus 100.

The memory 3 of the communication assisting apparatus 100 may store the data to be shared by the network. In the above case, the memory 3 may be provided by an unrewritable non-volatile memory. When a non-volatile memory is adopted, only read operation is executed. The CPU 1 of the communication assisting apparatus 100 independently controls the memory 3 according to request signals from the other PCs, and then transfers the data stored in the memory 3. Therefore, the PC 111 can continue the processing without being interrupted by the requests of access from the other apparatuses including the PC 112. It is not necessary to execute any security setting since the HDD 111h itself of the PC 111 is not required to be shared. Also, in this regard, there can be achieved an improvement in the operating efficiency and stabilization of operation.

FIG. 3 shows a data transfer flow from the PC 111 to the PC 112, and data transfer from the PC 112 to the PC 111 is also executed quite similarly. The communication assisting apparatus 100 is only required to by wireless receive data from the PC 112, temporarily store the data in the memory 3 and thereafter transfer the data to the PC 111 at an appropriate timing. The CPU 1 of the communication assisting apparatus 100 transfers a signal converted in conformity to the signal system appropriate for the wire connection controller 4 to the wire connection controller 4 by the transmit function. The wire connection controller 4, which receives the signal, converts the received signal into a signal of the USB standard, and outputs the resulting signal to the PC 111. By this operation, the PC 111 is not required to await the completion of communication as a consequence of the end of data processing even when, for example, the data processing speed of the PC 112 is slower than the data processing speed of the PC 111. At the timing when the data transfer from the PC 112 to the communication assisting apparatus 100 has been completed, the PC 111 is required to read out the data stored in the memory of the communication assisting apparatus 100. Moreover, the recent PCs are often equipped with an USB interface as a standard, and by constituting the communication assisting apparatus 100 employing an USB terminal unit as described above, the communication assisting apparatus 100 can be used without altering any setting of the communication assisting apparatus 100 even if the PC to be used is changed. Therefore, the work can be performed as usual even in a use environment different from the normal use environment. Moreover, the function can be added via the USB terminal unit to the PC that does not have the function corresponding to the BT standard. Accordingly, it is not necessary to purchase a new PC, and this is economically advantageous.

In the above-mentioned description, the data is temporarily stored in the memory 3. However, for example, when a satisfactory communication state can be established with a data transfer rate equal to or larger than a predetermined value, it is also possible to transfer the data directly to the transfer destination without storing the data in the memory 3 of FIG. 2. It is preferable to transfer the data while storing the data in the memory 3 since it is considered that the state of communication might suddenly deteriorate.

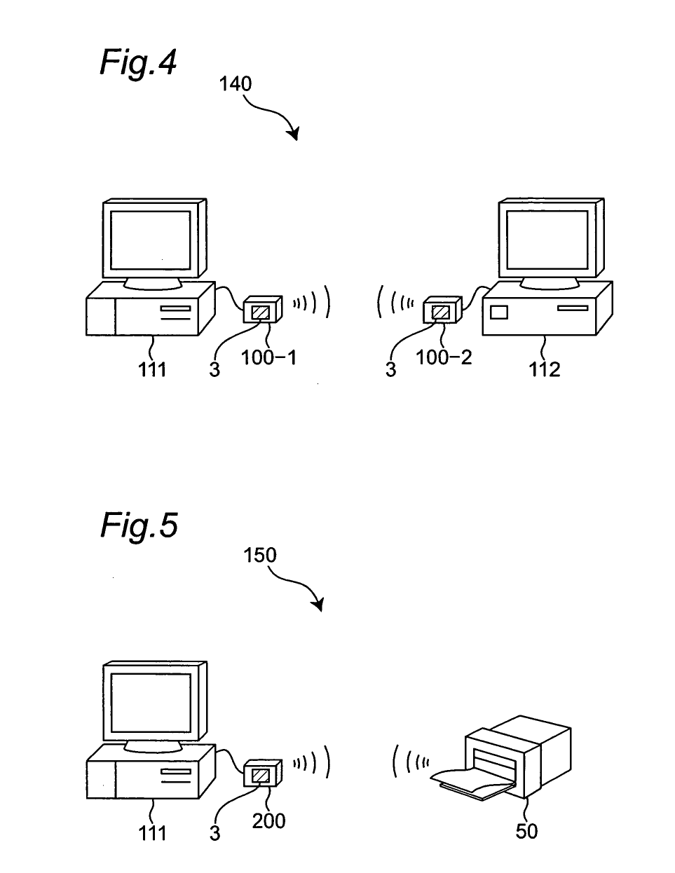

FIG. 4 is a schematic perspective view showing a communication system 140 of a first modified preferred embodiment of the present invention. The point of difference from the communication system 110 of FIG. 1 is that both of the PCs 111 and 112 have communication assisting apparatuses 100-1 and 100-2, respectively. The structures of the communication assisting apparatuses 100-1 and 100-2 are quite the same as the structure of the communication assisting apparatus 100 shown in FIG. 2. A data transfer procedure is quite similar to that of FIG. 3 except for such a point of difference that the communication assisting apparatus 100-2 is interposed between the communication assisting apparatuses 100-1 and the PC 112.

The data transfer procedure executed by the communication system 140 will be described. Data transferred from the PC 111 to the communication assisting apparatus 100-1 is stored in the memory 3 of the communication assisting apparatus 100-1, and thereafter, the data is transmitted to the communication assisting apparatus 100-2 at an appropriate timing. Otherwise, the data is immediately transferred to the communication assisting apparatus 100-2 without being stored in the memory 3. The communication assisting apparatus 100-2 stores the received data in the internal memory 3, and transfers the stored data to the PC 112 at an appropriate timing. By this operation, the data can be transferred from the PC 111 to the PC 112.

As described above, by providing the communication assisting apparatuses 100-1 and 100-2 respectively for both the PCs 111 and 112 of the side of transmitter (or transfer originator) and the side of receiver (or transfer destination), the objective data to be transferred can be stored in one or both of the memories 3 of the communication assisting apparatuses 100-1 and 100-2. Therefore, the above-mentioned advantageous effects are obtained in the PC 111 of the side of transmitter. Further, in the PC 112 of the side of receiver, the other processing can be executed regardless of whether or not communication is executed, and data can be received at an appropriate timing during subsequent idling time or the like. Therefore, improvement in the operating efficiency and stabilization of operation can be achieved also in the PC 112 of the transfer destination.

Second Preferred Embodiment

FIG. 5 is a schematic perspective view showing a communication system 150 according to the second preferred embodiment of the present invention. The communication system 150 is constituted by connecting two kinds of data processing apparatuses, i.e., the PC 111 and a printer 50 so that the PC 111 and the printer can communicate with each other. Although only the PC 111 and the printer only 50 are shown in FIG. 5, a plurality of PCs may share one printer 50. That is, the printer 50 is a so-called network printer. The printing operation of the printer 50 for printing print data from the PC 111 will be described on the assumption that the PC 111 is located on the side of data transmitter and the printer 50 is located on the side of data receiver.

A second communication assisting apparatus 200, which is obtained by modifying the communication assisting apparatus 100 of FIG. 2, is connected with the PC 111. In the communication system 150, the PC 111 and the printer 50 execute data communication via the communication assisting apparatus 200. The communication system 150 and the components constituting the communication system 150 are quite the same as those of the communication system 110 of FIG. 1 described in connection with the first preferred embodiment except for the communication assisting apparatus 200 used in place of the communication assisting apparatus 100 of FIG. 2 and the printer 50 used in place of the PC 112 of FIG. 1. For example, the communication assisting apparatus 200 is also provided with an internal memory 3 for data storage and stores data from the PC 111 temporarily in the memory 3 when the PC 111 transmits the data to the printer 50. The communication assisting apparatus 200, printer 50, and the points of difference of the communication procedure upon using these components will be described below.

The features of the communication assisting apparatus 200 is to provide an area for storing specified fixed data in the internal memory 3, and to that the fixed data is transferred together with the data from the PC 111 during communication. In this case, the “fixed data” means environmental data of document layout setting data, character font data, a translation table of setting values corresponding to printer manufacturers and so on, and are stored in a non-volatile memory area of a mask ROM, an EEPROM or the like.

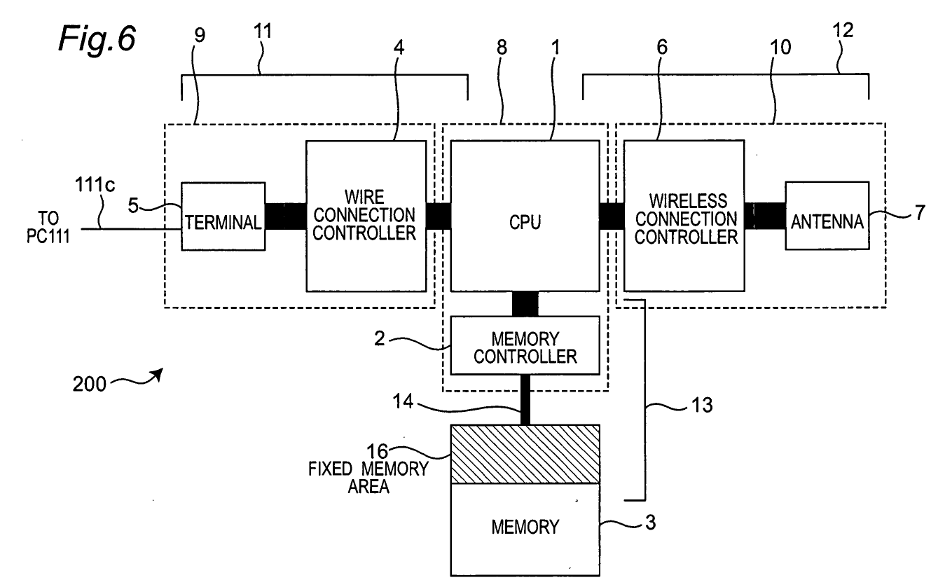

Further details will be described below. FIG. 6 is a block diagram showing a construction of the communication assisting apparatus 200 of the second preferred embodiment of the present invention. The communication assisting apparatus 200 is different from the communication assisting apparatus 100 of FIG. 2 in that it is provided with a fixed memory area 16. The other components and the operations thereof are the same as those of the communication assisting apparatus 100 of FIG. 2, and therefore, no description is provided therefor.

The fixed memory area 16 is made of a non-volatile memory area in which the fixed data is stored as described above. A memory controller 2 can independently read out data from the fixed memory area 16 and the memory 3, and can write data into the memory 3. By providing such a dual port function that a plurality of write and read paths 13 from the CPU 1 to the memory 3 are provided, smoother processing can be achieved. Since there are few opportunities to alter the environmental data of the character font data and so on, if the environmental data is stored as fixed data in the non-volatile memory, it is not necessary to provide no backup power supply. Furthermore, if a mask ROM is employed, there is also such an advantageous effect-that the cost can be reduced.

The reason for storing the environmental data as described above in the fixed memory area 16 is as follows. Conventionally, upon printing out document data or the like, it is often the case where document layouts, character font types, character sizes and so on are determined upon making documents, and the normally used printer prints out the document according to the setting by the user. This printer can print out the document that the user intends by preparatorily retaining desired character fonts in a built-in memory or receiving font data from a PC or the like upon printing out.

However, upon executing printout in an environment different from the usual one, it is sometimes impossible to print out the document that the user intends. This occurs when the user's own printer cannot be used and the printer in a relocation site does not have the set character font. In the above case, the font is sometimes substituted by another character font or not correctly expressed (mis-converted to generate garbled characters). For example, when document data is stored in a removal medium of a flexible disk or the like and subjected to printout by means of a PC at a location abroad during a visit for a business trip, garbled characters are generated. This is because the PC and the printer at the location abroad do not normally have Chinese characters and Japanese Kana fonts.

Moreover, the document layout depends on various printer setting values of sheet feed rate, printable range and so on in almost all the cases. However, the default values are often different from each other depending on the printer manufacturers. In order to achieve a desired layout, it takes some troubles to repeat printout or similar measures.

For the above reasons, the fixed memory area 16 of the communication assisting apparatus 200 is provided, and the environmental data of the layout setting data, the character font data and the translation table of the setting values corresponding to the printer manufacturers are stored in the fixed memory area 16. By transferring the environmental data stored in the fixed memory area 16 to the printer when the user printouts in a use environment different from the usual one, the printer can set the operating conditions on the basis of the environmental data. Through these processes, the user can printout desired contents. The communication assisting apparatus 200 is easily made portable by being manufactured in a size close to the PC card size, and therefore, the apparatus can be made portable also in a use environment different from the usual one.

Also, in the communication assisting apparatus 200, the data transferred from the PC 111 of FIG. 5 in a manner similar to that of the communication assisting apparatus 100 of FIG. 2 of the first preferred embodiment is temporarily stored in the memory 3. Then, upon transferring the data to the printer 50 of FIG. 5, the CPU 1 issues a command to the memory controller 2 to obtain the environmental data. The read environmental data is transferred to the printer 50 at an appropriate timing. When, for example, the printer 50 needs the character font data and the setting value data before the document data, the CPU 1 transfers the environmental data to the printer 50 at the timing when connection with the printer 50 before the reception of print data is established. Moreover, when the printer 50 needs the environmental data after the document data, the CPU 1 transfers the environmental data after the transfer of the document data. The CPU 1 may specify necessary font data, layout setting data and so on after receiving the print data and transfer only necessary data to the printer 50.

Data transmission from the printer 50 to the PC 111 is also possible. The contents of data includes, for example, information of the completion of printout, a report when the printout has not been completed due to accidental troubles of sheet empty, ink empty and so on. The PC 111 can continue processing without being sensible of troublesome works other than the information of the completion of printout and the items (information about sheet empty, ink empty and so on) that cannot be processed by the CPU 1.

According to the above description, the object to be printed has been the document data. However, the data may be image data or data formed by the other software. That is, in the case of data that similarly requires the setting values and the character font data during printout, the data can be preparatorily stored in the fixed memory area 16.

When the printer 50 can execute printout of the document data without any control signal from the PC according to its original function or when the printer can directly analyze the document data (in the case of, for example, machine language or the like), it is possible to connect the communication assisting apparatus 200 with the printer 50 without connecting the apparatus 200 with the PC 111, and then, outputs the data to the printer 50. In this case, it is preferable to connect the apparatus with a power supply unit of a wired type, a battery type or the like to supply the apparatus with an electric power, and then transfer data to the printer 50 by wire or by wireless.

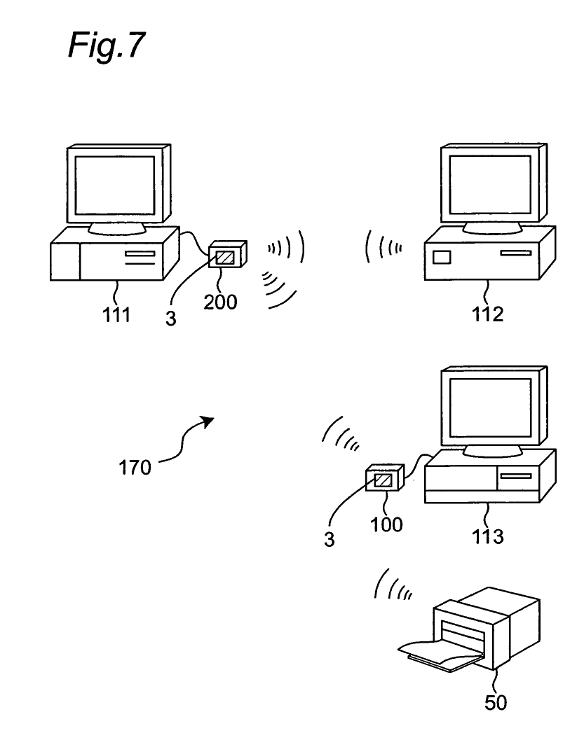

FIG. 7 is a view showing a communication system 170 including all the constructions of FIGS. 1, 4 and 5. The communication assisting apparatus 200 of FIG. 6 is employed for the PC 111, and the communication assisting apparatus 100 of FIG. 2 is employed for a PC 113. As described above, the communication assisting apparatus 200 is constituted in a manner similar to that of the communication assisting apparatus 100 except for the fixed memory area 16 of FIG. 6. Therefore, the actions and advantageous effects described in connection with the first preferred embodiment are the same as that even when the communication assisting apparatus 200 is employed. As described with reference to FIG. 1, the communication assisting apparatus 200 mediates data transfer between the PC 111 and the PC 112. Moreover, as described with reference to FIG. 4, the communication assisting apparatus 200 mediates data transfer between the PC 111 and the PC 113. Then, as described with reference to FIG. 5, the PC 111 mediates data transfer between the PC 111 and the printer 50. As described above, the communication assisting apparatus 100 and the communication assisting apparatus 200 of the present invention can be also used in combination, and the same advantageous effects as the above-mentioned effects can be concurrently obtained.

Although the main unit 8, the wire connection unit 9, the wireless connection unit 10 and so on have been described by being individually expressed in the preferred embodiments described above, this is mere expression segmented in function blocks. If the functions of these units are integrated and mounted, such an arrangement belongs to the scope of the present invention.

Moreover, the communication assisting apparatus of the present invention is not always required to have a wire connection unit and a wireless connection unit. If the above-mentioned advantageous effects are obtained, only a wireless connection unit may be provided. Furthermore, although the communication assisting apparatus of the present invention is shown in a body separated from the PC 111 and so on in the figures, the communication assisting apparatus may be built in the PC 111 or the like.

Advantageous Effects of Preferred Embodiments

Upon receiving data from a data processing apparatus of the side of transmitter (or the side of transfer originator), the communication assisting apparatus temporarily stores the data in the memory provided on the inside thereof. By this operation, the data processing apparatus located on the side of transmitter can shift to the next processing even when the data is not actually transferred. Therefore, the operating efficiency of the data processing apparatus located on the side of transmitter can be remarkably improved. In particular, the communication assisting apparatus transmits data by wireless, and therefore, the communication assisting apparatus can retransmit the data stored in the memory even if there is communication failure due to an obstacle or the like, which does not occur by wire, or random entry of an unrelated signal such as noise or the like. This can prevents from putting or reducing processing load on the data processing apparatus located on the side of transmitter. Moreover, the data processing apparatus is connected with no apparatus other than the communication assisting apparatus with regard to the transmission of the data, and therefore, the data processing apparatus can operate without being influenced by the state of communication with the data processing apparatus located on the transfer destination side and so on. Therefore, stabilization of operation can be also achieved.

Further, by respectively connecting communication the assisting apparatuses with respective ones of the data processing apparatuses located on the side of transmitter and the side of receiver, the data processing apparatus located on the side of transmitter has the above-mentioned advantageous effects, and the data processing apparatus located on the side of receiver is required to execute data reception processing after completion of data reception by wireless communication. Therefore, efficient operations can be achieved in each of the data processing apparatuses.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A communication assisting apparatus for mediating data transfer between a first data processing apparatus and a second data processing apparatus, comprising:
a first connection unit connected by wire with said first data processing apparatus, said first connection unit receiving data from said first data processing apparatus;
a memory for storing therein the data received by said first connection unit; and
a second connection unit connected by wireless with said second data processing apparatus, said second connection unit transmitting the data read out from said memory to said second data processing apparatus.

2. The communication assisting apparatus according to claim 1, further comprising:
a processing section for reading out the data stored in said memory according to a state of communication with said second data processing apparatus.

3. The communication assisting apparatus according to claim 2,
wherein said processing section suspends data transfer of the data stored in said memory until communication with said second data processing apparatus is established.

4. The communication assisting apparatus according to claim 1,
wherein said second connection unit receives further data different from the data stored in said memory, by wireless from said second data processing apparatus,
wherein said memory stores therein the further data received by said second connection unit, and
wherein said first connection unit transmits the further data read out from said memory to said first data processing apparatus.

5. The communication assisting apparatus according to claim 2,
wherein said memory includes at least one of a rewritable non-volatile memory and a volatile memory.

6. The communication assisting apparatus according to claim 5,
wherein said rewritable non-volatile memory stores environmental data for setting operating conditions which is used by said second data processing apparatus,
wherein said processing section further reads out the environmental data upon reading out the data stored in said memory, and
wherein said second connection unit transmits the environmental data read out by said processing section to said second data processing apparatus.

7. A communication system for performing data transfer a first data processing apparatus and a second data processing apparatus, comprising:
a first communication assisting apparatus connected by wire with said first data processing apparatus; and
a second communication assisting apparatus connected by wireless with said second data processing apparatus,
wherein said first communication assisting apparatus comprises:
a first wire connection unit for receiving data from said first data processing apparatus;
a first memory for storing the data received by said first wire connection unit; and
a first wireless connection unit connected by wireless with said second communication assisting apparatus, said first wireless connection unit transmitting the data read out from said first memory to said second communication assisting apparatus, and
wherein said second communication assisting apparatus comprises:
a second wireless connection unit connected by wireless with said first communication assisting apparatus, said second wireless connection unit receiving data from said first communication assisting apparatus;
a second memory for storing the data received by said second wireless connection unit; and
a second wire connection unit for transmitting the data read out from said second memory to said second data processing apparatus.
